(19) United States
(12) Patent Application Publication
(10) Pub. No.: US 2014/0269552 A1
(43) Pub. Date: Sep. 18, 2014

(54) COMMUNICATION SYSTEM, COMMUNICATION METHOD, MOBILE TERMINAL, AND CONTROL APPARATUS

(71) Applicant: FUJITSU LIMITED, Kawasaki-shi (JP)

(72) Inventor: NARITOSHI SAITO, Hino (JP)

(73) Assignee: FUJITSU LIMITED, Kawasaki-shi (JP)

(21) Appl. No.: 14/138,702

(22) Filed: Dec. 23, 2013

(30) Foreign Application Priority Data
Mar. 18, 2013 (JP) 2013-055690

(51) Int. Cl. H04L 5/00

(52) U.S. Cl. CPC H04L 5/0058
USPC 370/329

(57) ABSTRACT

A communication system includes a mobile terminal that can receive wireless signals by concurrently using cells respectively of a first and a second frequency bandwidth, the latter cell having a range narrower than the former cell. The mobile terminal further transmits state information that indicates at least the presence/absence of power supply to the mobile terminal or the remaining battery amount of the mobile terminal. The communication system further includes a control apparatus that allocates communication resources for the wireless signal that is transmitted by a base station to the mobile terminal. The control apparatus switches according to the state information transmitted by the mobile terminal, a first allocation process of allocating the first and the second frequency bandwidths for the wireless signal and a second allocation process of allocating the first frequency bandwidth or the second frequency bandwidth for the wireless signal.

### CROSS REFERENCE TO RELATED APPLICATIONS

This application is based upon and claims the benefit of priority of the prior Japanese Patent Application No. 2013-055690, filed on Mar. 18, 2013, the entire contents of which are incorporated herein by reference.

### FIELD

The embodiments discussed herein are related to a communication system, a communication method, a mobile terminal, and a control apparatus.

### BACKGROUND

Long Term Evolution (LTE) and LTE-Advanced (LTE-A) are conventionally known mobile communication schemes. Under LTE and LTE-A, for example, Orthogonal Frequency Division Multiplexing Access (OFDMA) is used.

Under LTE-A, carrier aggregation (CA), which bundles and uses multiple component carriers (CC), is employed. The carrier aggregation includes selecting a primary cell (main cell) and a secondary cell (sub-cell), for example. Further, the allocation of communication resources is performed based on the reception quality at mobile terminals of cells.

According to a known technique, when the electric power available to a terminal changes, the terminal side notifies the network side of the change (see, e.g., Japanese Laid-Open Patent Publication No. 2009-165132). A technique of carrier aggregation based on channel quality is known (see, e.g., Japanese Laid-Open Patent Publication No. 2012-044663). A technique of carrier aggregation is known that concurrently uses carriers having different widths of coverage areas (see, e.g., Japanese Laid-Open Patent Publication No. 2011-142596).

However, the conventional techniques described above have a problem in that even when communication resources are allocated based on reception quality of a mobile terminal, in some states of the mobile terminal, the communication resources cannot efficiently be used.

### SUMMARY

According to an aspect of an embodiment, a communication system includes a mobile terminal that is configured to enable reception of a wireless signal by concurrently using a cell of a first frequency bandwidth and a cell of a second frequency bandwidth that is different from the first frequency bandwidth, the cell of the second frequency bandwidth having a range narrower than the cell of the first frequency bandwidth, the mobile terminal transmitting state information that indicates at least one among presence/absence of power supply to the mobile terminal and a remaining battery amount of the mobile terminal; and a control apparatus that is configured to allocate communication resources for a wireless signal transmitted by a base station to the mobile terminal, the control apparatus switching according to the state information transmitted by the mobile terminal, a first allocation process of allocating the first frequency bandwidth and the second frequency bandwidth for the wireless signal and a second allocation process of allocating one among the first frequency bandwidth and the second frequency bandwidth for the wireless signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram of an example of a communication system according to a first embodiment;

FIG. 1B is a diagram of an example of a signal flow in the communication system depicted in FIG. 1A;

FIG. 1C depicts an example of cells that can be used for reception of a wireless signal by a mobile terminal;

FIG. 2 is a diagram of an example of carrier aggregation;

FIG. 3 is a diagram of an example of frame mapping of a downlink physical channel;

FIG. 4 is a sequence diagram of an example of message flow between the mobile terminal and a network;

FIG. 5 is a diagram of an example of an event group that is checked;

FIG. 6 is a flowchart of an example of a report operation for reporting Event S1;

FIG. 7A is a diagram of an example of report information for Event S1;

FIG. 7B is a diagram of an example of power supply information;

FIG. 7C is a diagram of an example of remaining battery amount information;

FIG. 7D is a diagram of an example of movement speed information;

FIG. 7E is a diagram of an example of requested downlink throughput information;

FIG. 8 is a sequence diagram of an example of a protocol flow of the reporting of Event S1 and the resource allocation;

FIG. 9A is a diagram of an example of the timing of a signal transmitted from the base station to the mobile terminal;

FIG. 9B is a diagram of an example of the timing of a signal transmitted from the mobile terminal to the base station;

FIG. 10 is a diagram of an example of a CQI table;

FIG. 11 is an example of sub-bandwidths obtained by dividing system bandwidth;

FIG. 12 is a flowchart of an example of a category determination process;

FIG. 13 is a flowchart of an example of a resource allocation process;

FIG. 14A is a diagram of an example of a configuration of the mobile terminal according to the first embodiment;

FIG. 14B is a diagram of an example of signal flow in the configuration of the mobile terminal depicted in FIG. 14A;

FIG. 15 is a diagram of an example of a detection of the requested downlink throughput;

FIG. 16A is a diagram of an example of a configuration of a base station according to the first embodiment;

FIG. 16B is a diagram of signal flow in the configuration of the base station depicted in FIG. 16A;

FIG. 17 is a diagram of an example of the report information transmitted by the mobile terminal according to a second embodiment;

FIG. 18 is a diagram of an example of category information;

FIG. 19 is a sequence diagram of an example of protocol flow of the reporting of the category and the resource allocation;

FIG. 20A is a diagram of an example of a configuration of the mobile terminal according to the second embodiment;

FIG. 20B is a diagram of an example of signal flow in the configuration of the mobile terminal depicted in FIG. 20A;

FIG. 21A is a diagram of an example of a configuration of the base station according to the second embodiment; and

FIG. 21B is a diagram of signal flow in the configuration of the base station depicted in FIG. 21A.

### DESCRIPTION OF EMBODIMENTS

Embodiments of a communication system, a communication method, a mobile terminal, and a control apparatus will be described in detail with reference to the accompanying drawings.

FIG. 1A is a diagram of an example of a communication system according to a first embodiment. FIG. 1B is a diagram of an example of a signal flow in the communication system depicted in FIG. 1A. FIG. 1C depicts an example of cells that can be used for reception of a wireless signal by a mobile terminal.

As depicted in FIGS. 1A and 1B, a communication system 100 according to the first embodiment includes a mobile terminal 110, a base station 120, and a control apparatus 121. The mobile terminal 110 performs wireless communication with the base station 120. The base station 120 may be multiple base stations. The control apparatus 121 may be an apparatus disposed on the base station 120 or may be an apparatus disposed outside the base station 120 and capable of communicating with the base station 120.

Cells 131, 132, and a cell group 133 depicted in FIG. 1C are cells that can be used by the mobile terminal 110 to receive wireless signals. The cells 131 and 132 are cells that use a first frequency bandwidth b1. The cell group 133 is made up of cells that use a second frequency bandwidth b2 that is different from the first frequency bandwidth b1. As depicted in FIG. 1C, the cells of the cell group 133 are cells that overlap at least any one among the cells 131 and 132, and cover a range (coverage area) that is smaller than the cells 131 and 132.

A cell of the second frequency bandwidth b2 is a cell having a range that is smaller than a cell of the first frequency bandwidth b1 and therefore, if the mobile terminal 110 moves at high speed, communication quality deteriorates more frequently and for example, communication is interrupted more frequently, in a cell of the second frequency bandwidth b2 as compared to a cell of the first frequency bandwidth b1.

As depicted in FIGS. 1A and 1B, the mobile terminal 110 includes a detecting unit 111, a transmitting unit 112, and a receiving unit 113. The detecting unit 111 detects a state of the mobile terminal 110 (thereof). The mobile terminal 110 state detected by the detecting unit 111 includes at least one among presence/absence of power supply to the mobile terminal 110 and a remaining battery amount of the mobile terminal 110. The detecting unit 111 outputs to the transmitting unit 112, state information indicating a result of detection.

The transmitting unit 112 transmits to the control apparatus 121, the state information output from the detecting unit 111. For example, if the control apparatus 121 is disposed on the base station 120, the transmitting unit 112 transmits the state information to the base station 120. If the control apparatus 121 is disposed outside the base station 120, the transmitting unit 112 transmits the state information via the base station 120 to the control apparatus 121. For example, a control channel is used for the transmission of the state information by the transmitting unit 112.

The receiving unit 113 receives wireless downlink signals from the base station 120. The receiving unit 113 can receive the wireless signals by concurrently using a cell of the first frequency bandwidth b1 (e.g., either of the cells 131 and 132) and a cell of the second frequency bandwidth b2 (e.g., any cell in the cell group 133) depicted in FIG. 1C.

The receiving unit 113 receives the wireless signals from the base station 120 through communication resources allocated by the control apparatus 121 based on the state information transmitted by the transmitting unit 112. For example, the receiving unit 113 receives from the base station 120, a result of communication resource allocation by the control apparatus 121 and receives the wireless signals from the base station 120 based on the received allocation result. For example, the control channel is used for the reception of the allocation result by the receiving unit 113.

The mobile terminal 110 measures reception quality for the cells (including sectors) of the first frequency bandwidth b1 and the second frequency bandwidth b2. The reception quality measurement by the mobile terminal 110 is a cell search that measures path loss for each cell, for example. The reception quality measured by the mobile terminal 110 is, for example, Received Signal Strength Indicator (RSSI) or Carrier to Interference and Noise Ratio (CINR). The mobile terminal 110 wirelessly transmits information including a result of the measurement of the reception quality to the control apparatus 121. The control apparatus 121 performs resource allocation based on the reception quality measurement results from the mobile terminal 110 and the state information from the mobile terminal 110.

The control apparatus 121 includes a receiving unit 122 and an allocating unit 123. The receiving unit 122 receives the state information transmitted from the mobile terminal 110. The receiving unit 122 outputs the received state information to the allocating unit 123.

The allocating unit 123 allocates communication resources to a wireless signal transmitted from the base station 120 to the mobile terminal 110. The allocating unit 123 switches a first allocation process and a second allocation process based on the state information output from the receiving unit 122. The first allocation process is an allocation process of allocating the first frequency bandwidth b1 and the second frequency bandwidth b2 to the wireless signals headed to the mobile terminal 110. The second allocation process is an allocation process of allocating one of the first frequency bandwidth b1 and the second frequency bandwidth b2 to the wireless signals headed to the mobile terminal 110.

For example, description will be made of a case where the state information transmitted from the mobile terminal 110 is state information that indicates the presence/absence of power supply to the mobile terminal 110. In this case, the allocating unit 123 allocates the communication resources through the first allocation process if the mobile terminal 110 is supplied with power. The allocating unit 123 allocates the communication resources through the second allocation process if the mobile terminal 110 is not supplied with power.

As a result, if the mobile terminal 110 is supplied with power, the wireless signal can be transmitted from the base station 120 to the mobile terminal 110 by using the first frequency bandwidth b1 and the second frequency bandwidth b2. If the mobile terminal 110 is not supplied with power, the wireless signal can be transmitted by using only one of the first frequency bandwidth b1 and the second frequency bandwidth b2.

Therefore, the power consumption of the mobile terminal 110 can be prevented from increasing due to using both the first frequency bandwidth b1 and the second frequency bandwidth b2 for receiving the wireless signal even though the mobile terminal 110 is not supplied with power. If the mobile terminal 110 is supplied with power, the communication quality of the mobile terminal 110 can be improved by using both the first frequency bandwidth b1 and the second frequency bandwidth b2 for receiving the wireless signal.

Description will be made of a case where the state information transmitted from the mobile terminal 110 is state information that indicates a remaining battery amount of the mobile terminal 110. In this case, the allocating unit 123 allocates the communication resources through the first allocation process if the remaining battery amount of the mobile terminal 110 is greater than a predetermined first remaining amount. The allocating unit 123 allocates the communication resources through the second allocation process if the remaining battery amount of the mobile terminal 110 is less than a predetermined second remaining amount. The second remaining amount is a value less than or equal to the first remaining amount. If the remaining battery amount of the mobile terminal 110 is less than or equal to the first remaining amount and greater than or equal to the second remaining amount, the allocation of the communication resources is not particularly limited.

As a result, if the remaining battery amount of the mobile terminal 110 is high, the wireless signal can be transmitted from the base station 120 to the mobile terminal 110 by using the first frequency bandwidth b1 and the second frequency bandwidth b2. If the remaining battery amount of the mobile terminal 110 is low, the wireless signal can be transmitted by using only one of the first frequency bandwidth b1 and the second frequency bandwidth b2.

Therefore, the power consumption of the mobile terminal 110 can be prevented from increasing due to using both the first frequency bandwidth b1 and the second frequency bandwidth b2 to receive the wireless signal even though the remaining battery amount of the mobile terminal 110 is low. If the remaining battery amount of the mobile terminal 110 is high, the communication quality of the mobile terminal 110 can be improved by using both the first frequency bandwidth b1 and the second frequency bandwidth b2 to receive the wireless signal.

Description will be made of a case where the state information transmitted from the mobile terminal 110 is state information that indicates the presence/absence of power supply to the mobile terminal 110 and the remaining battery amount of the mobile terminal 110. In this case, if the mobile terminal 110 is supplied with power or if the remaining battery amount of the mobile terminal 110 is greater than the first remaining amount, the allocating unit 123 allocates the communication resources through the first allocation process. If the mobile terminal 110 is not supplied with power and the remaining battery amount of the mobile terminal 110 is less than the second remaining amount, the allocating unit 123 allocates the communication resources through the second allocation process.

As a result, if the mobile terminal 110 is supplied with power or if the remaining battery amount of the mobile terminal 110 is high, the wireless signal can be transmitted from the base station 120 to the mobile terminal 110 by using the first frequency bandwidth b1 and the second frequency bandwidth b2. If the mobile terminal 110 is not supplied with power and the remaining battery amount of the mobile terminal 110 is low, the wireless signal can be transmitted by using only one of the first frequency bandwidth b1 and the second frequency bandwidth b2.

Therefore, the power consumption of the mobile terminal 110 can be prevented from increasing due to using both the first frequency bandwidth b1 and the second frequency bandwidth b2 to receive the wireless signal even though the mobile terminal 110 is not supplied with power and the remaining battery amount of the mobile terminal 110 is low. If the mobile terminal 110 is supplied with power or has a high remaining battery amount, the communication quality of the mobile terminal 110 can be improved by using both the first frequency bandwidth b1 and the second frequency bandwidth b2 for receiving the wireless signal.

As described above, the control apparatus 121 can perform the resource allocation with consideration of at least one among the presence/absence of power supply to the mobile terminal 110 and the remaining battery amount of the mobile terminal 110 reported by the mobile terminal 110, thereby efficiently using the communication resources.

The detecting unit 111 of the mobile terminal 110 may also detect a data amount (requested downlink throughput) requested for transmission from the base station 120 to the mobile terminal 110. For example, the detecting unit 111 detects a data amount that corresponds to the state of an application under execution by the mobile terminal 110, based on correlation information concerning the state of an application executable at the mobile terminal 110 and the data amount requested by the mobile terminal 110.

In this case, the allocating unit 123 of the control apparatus 121 acquires from receiving unit 122, state information that indicates the data amount requested for transmission from the base station 120 to the mobile terminal 110. The allocating unit 123 switches based on at least any one among the presence/absence of power supply to the mobile terminal 110 and the remaining battery amount of the mobile terminal 110, an allocation process having a predetermined data amount as an upper limit and an allocation process performed according to the data amount indicated by the state information. The allocation process performed according to the data amount indicated by the state information is an allocation process that enables allocation exceeding the predetermined data amount and enables allocation of more communication resources than the allocation process that has a predetermined data amount as an upper limit.

For example, description will be made of a case where the state information transmitted from the mobile terminal 110 is state information that indicates the presence/absence of power supply to the mobile terminal 110. In this case, if the mobile terminal 110 is supplied with power, the allocating unit 123 allocates the communication resources through a first allocation process that according to the data amount indicated by the state information, enabling allocation exceeding the predetermined data amount. If the mobile terminal 110 is not supplied with power, the allocating unit 123 allocates the communication resources through a second allocation process that has the predetermined data amount as an upper limit.

As a result, if the mobile terminal 110 is supplied with power, the wireless signal can be transmitted from the base station 120 to the mobile terminal 110 by using more communication resources of the first frequency bandwidth b1 and the second frequency bandwidth b2. If the mobile terminal 110 is not supplied with power, the wireless signal can be transmitted by limiting the data amount and using one among the first frequency bandwidth b1 and the second frequency bandwidth b2.

Therefore, the power consumption of the mobile terminal 110 can be prevented from increasing due to using more communication resources for reception of the wireless signal when the mobile terminal 110 is not supplied with power. If the mobile terminal 110 is supplied with power, the communication quality of the mobile terminal 110 can be improved by using more communication resources for reception of the wireless signal.

Description will be made of a case where the state information transmitted from the mobile terminal 110 is state information that indicates the remaining battery amount of the mobile terminal 110. In this case, if the remaining battery amount of the mobile terminal 110 is higher than the predetermined first remaining amount, the allocating unit 123 allocates the communication resources through the first allocation process that according to the data amount indicated by the state information, enabling allocation exceeding the predetermined data amount. If the remaining battery amount of the mobile terminal 110 is lower than the predetermined second remaining amount, the allocating unit 123 allocates the communication resources through the second allocation process that has the predetermined data amount as an upper limit.

As a result, if the remaining battery amount of the mobile terminal 110 is high, the wireless signal can be transmitted from the base station 120 to the mobile terminal 110 by using more communication resources of the first frequency bandwidth b1 and the second frequency bandwidth b2. If the remaining battery amount of the mobile terminal 110 is low, the wireless signal can be transmitted by limiting the data amount and using one among the first frequency bandwidth b1 and the second frequency bandwidth b2.

Therefore, the power consumption of the mobile terminal 110 can be prevented from increasing due to using more communication resources for reception of the wireless signal when the remaining battery amount of the mobile terminal 110 is low. If the remaining battery amount of the mobile terminal 110 is high, the communication quality of the mobile terminal 110 can be improved by using more communication resources.

Description will be made of a case where the state information transmitted from the mobile terminal 110 is state information that indicates both the presence/absence of power supply to the mobile terminal 110 and the remaining battery amount of the mobile terminal 110. In this case, if the mobile terminal 110 is supplied with power or if the remaining battery amount of the mobile terminal 110 is higher than the first remaining amount, the allocating unit 123 executes the first allocation process that according to the data amount indicated by the state information, enabling allocation exceeding the predetermined data amount. If the mobile terminal 110 is not supplied with power and the remaining battery amount of the mobile terminal 110 is smaller than the second remaining amount, the allocating unit 123 allocates the communication resources through the second allocation process, which has the predetermined data amount as an upper limit.

As a result, if the mobile terminal 110 is supplied with power or if the remaining battery amount of the mobile terminal 110 is high, the wireless signal can be transmitted from the base station 120 to the mobile terminal 110 by using more communication resources of the first frequency bandwidth b1 and the second frequency bandwidth b2. If the mobile terminal 110 is not supplied with power and the remaining battery amount of the mobile terminal 110 is low, the wireless signal can be transmitted by limiting the data amount and using one among the first frequency bandwidth b1 and the second frequency bandwidth b2.

Therefore, the power consumption of the mobile terminal 110 can be prevented from increasing due to using more communication resources for reception of the wireless signal in the mobile terminal 110 when the mobile terminal 110 is not supplied with power and the remaining battery amount of the mobile terminal 110 is low. If the mobile terminal 110 is supplied with power or if the remaining battery amount of the mobile terminal 110 is high in the mobile terminal 110, the communication quality of the mobile terminal 110 can be improved by using more communication resources for reception of the wireless signal.

The detecting unit 111 of the mobile terminal 110 may also detect a movement speed of the mobile terminal 110. The movement speed detected by the mobile terminal 110 is, for example, an average movement speed during an immediately preceding predetermined period (e.g., including a movement average value). The predetermined period for calculating the average movement speed may be about five to ten minutes, for example.

The allocating unit 123 of the control apparatus 121 acquires from receiving unit 122, state information that indicates the movement speed of the mobile terminal 110. The allocating unit 123 allocates the communication resources for the wireless signal to the mobile terminal 110 such that the ratio between the first frequency bandwidth b1 and the second frequency bandwidth b2 differs according to the movement speed indicated by the state information.

For example, when the movement speed of the mobile terminal 110 is lower than a predetermined first speed, the allocating unit 123 performs allocation such that the ratio of the second frequency bandwidth b2 to the first frequency bandwidth b1 is larger as compared to when the movement speed of the mobile terminal 110 is higher than a predetermined second speed. The second speed is speed greater than or equal to the first speed.

As a result, during low-speed movement or during a stop while communication is stabilized even in smaller cells, the mobile terminal 110 can use more of the narrower second frequency bandwidth b2 to make the wide-area first frequency bandwidth b1 available for another terminal with unstable communication such as a mobile terminal moving at high speed. During high-speed movement while communication is unstable, the mobile terminal 110 can use more of the wide-area first frequency bandwidth b1 to stabilize the communication of the mobile terminal 110. Therefore, the communication resources can be used efficiently.

As described above, in the communication system 100, the mobile terminal 110 notifies the control apparatus 121 (network side) of a state of the terminal such as the remaining battery amount. The control apparatus 121 allocates downlink resources with consideration of the state provided from the mobile terminal 110. As a result, the communication resources can be used efficiently.

The communication system 100 is applicable to a mobile terminal capable of wireless communication such as LTE, LTE-A, and via a wireless local area network (WLAN), for example. A case where the communication system 100 is applied to a communication system capable of LTE-A wireless communication will be described hereinafter.

FIG. 2 is a diagram of an example of carrier aggregation. The horizontal axis of FIG. 2 indicates frequency. Bandwidth A depicted in FIG. 2 is a frequency bandwidth of 800 [MHz]. Bandwidth B is a frequency bandwidth of 3.5 [GHz] to 3.8 [GHz]. The carrier aggregation under LTE-A is performed by, for example, four component carriers including one component carrier 210 in bandwidth A and three component carries 221 to 223 in bandwidth B.

In this case, when it is assumed that a bandwidth of each of the component carriers 210 and 221 to 223 is 20 [MHz], a service can be performed with up to 80 [MHz] in width. Such carrier aggregation is referred to as inter frequency carrier aggregation, for example. Bandwidth A of 800 [MHz] is called, for example, a platinum bandwidth and compared to bandwidth B, enables easy signal reception.

The first frequency bandwidth b1 depicted in FIG. 1C corresponds to the bandwidth A depicted in FIG. 2, for example. The second frequency bandwidth b2 depicted in FIG. 1C corresponds to the bandwidth B depicted in FIG. 2, for example. The mobile terminal 110 uses, for example, the component carrier 210 of the bandwidth A as a primary component carrier (primary CC). The mobile terminal 110 uses the component carriers 221 to 223 of the bandwidth B as secondary component carriers (secondary CCs).

In this case, for the mobile terminal 110, a cell using the component carrier 210 is a primary cell and a cell using the component carriers 221 to 223 is a secondary cell.

FIG. 3 is a diagram of an example of frame mapping of a downlink physical channel. In FIG. 3, the horizontal direction indicates time and the vertical direction indicates frequency. The frame 310 represents one frame in the downlink physical channel in the mobile terminal 110. A length of the frame 310 is 10 [ms] and the frame 310 is repeatedly transmitted in the downlink physical channel. The frame 310 includes 10 sub-frames having a length of 1 [ms].

A sub-frame 320 represents one sub-frame in the frame 310. The sub-frame 320 includes two slots. A slot 330 represents one slot in the sub-frame 320. The slot 330 includes seven OFDM symbols. Each OFDM symbol of the slot 330 includes at the beginning a cyclic prefix (CP) that is a copy of an end portion of each symbol.

The sub-frame 320 includes, for example, a primary synchronization signal 321, a secondary synchronization signal 322, a physical broadcast channel (PBCH) 323, a physical downlink control channel (PDCCH) 324, a physical downlink shared channel (PDSCH) 325, and a reference signal (RS) 326. At the time of a cell search, the mobile terminal 110 executes a synchronization process by using the primary synchronization signal 321 and the secondary synchronization signal 322, thereby demodulating the cell ID to identify the cell.

The mobile terminal 110 measures RSSI, Reference Signal Received Power (RSRP), and Reference Signal Received Quality (RSRQ) based on the 3rd Generation Partnership Project (3GPP) Specification 36.214 under LTE-A, for example.

The measurement of RSSI is by wireless power measurement such as wireless power measurement of a signal with noise and interference components added in addition to a cell signal. The measurement of RSRP is by power measurement of the reference signal 326, for example. The reference signal 326 is mapped to symbol “0” and symbol “4” in each slot.

For example, RSRQ is acquired by dividing RSRP, which is power of the reference signal 326, by RSSI, and corresponds to Signal to Interference and Noise Ratio (SINR), for example.

FIG. 4 is a sequence diagram of an example of message flow between the mobile terminal and a network. The Evolved Universal Terrestrial Radio Access Network (EUTRAN) 410 depicted in FIG. 4 has a configuration corresponding to the control apparatus 121 depicted in FIGS. 1A and 1B.

The EUTRAN 410 is equipped at the base station 120, for example. The EUTRAN 410 may be provided in a higher-order communication apparatus than the base station 120. In this case, the mobile terminal 110 communicates with the EUTRAN 410, via the base station 120.

Under LTE-A (e.g., 3GPP TS36.331), for example, the following steps are periodically executed. First, the mobile terminal 110 transmits a measurement report to the EUTRAN 410 (step S401). The measurement report includes information based on measurement results of RSSI, RSRP, and RSRQ from the cell search described above, for example.

The EUTRAN 410 determines details of a setting change for the mobile terminal 110 (including “no change”) based on the measurement report transmitted at step S401 (step S402). The setting change may be, for example, an addition or cancellation of a secondary CC, a switching of the primary CC and a secondary CC, etc. The EUTRAN 410 transmits to the mobile terminal 110, a RRC connection reconfiguration including information indicating details of the setting change determined at step S402 (step S403).

The mobile terminal 110 makes the setting change based on the RRC connection reconfiguration transmitted at step S403 (step S404). The mobile terminal 110 transmits to the EUTRAN 410, “RRC connection reconfiguration complete” indicating the completion of the setting change (step S405) and terminates a sequence of the message flow.

According to the operations above, the EUTRAN 410 determines a setting change for the mobile terminal 110 based on the results of periodical cell searches in the mobile terminal 110, and the setting change of the mobile terminal 110 is performed according to the determination result.

FIG. 5 is a diagram of an example of an event group to be checked. The mobile terminal 110 checks events included in a table 500 depicted in FIG. 5, for example, periodically. The table 500 includes “Event A1” to “Event A6”, “Event B1”, “Event B2”, and “Event S1”.

“Event A1” to “Event A6”, “Event B1”, and “Event B2” are defined in TS36.331 of 3GPP, for example.

“Event A1” is an event occurring when power of a serving cell becomes better than a threshold value. “Event A2” is an event occurring when power of a serving cell becomes worse than a threshold value. “Event A3” is an event occurring when power of a neighbour cell becomes better than an offset determined by comparison with the primary cell.

“Event A4” is an event occurring when power of a neighbour cell becomes better than a threshold value. “Event A5” is an event occurring when the power of the primary cell becomes worse than a threshold value and power of a neighbour cell becomes better than a threshold value. “Event A6” is an event occurring when power of a neighbour cell becomes better than an offset determined by comparison with the power of the secondary cell.

“Event B1” is an event occurring when the power of a neighbour cell of Inter RAT (another wireless system) becomes better as compared to a threshold value. “Event B2” is an event occurring when the power of the primary cell becomes worse than a threshold value and power of a neighbour cell of Inter RAT (another wireless system) becomes better than a threshold value.

“Event S1” is an event occurring when a state of the mobile terminal 110 changes, for example. The state of the mobile terminal 110 includes the presence/absence of an external power supply, the remaining battery amount, the requested downlink throughput, the movement speed, etc. If “Event S1” occurs, the mobile terminal 110 transmits report information for reporting the occurring “Event S1” to the EUTRAN 410, for example, through a measurement report.

FIG. 6 is a flowchart of an example of a report operation for reporting Event S1. The mobile terminal 110 executes the following steps after the start of communication with the base station 120, for example. First, the mobile terminal 110 sets a timer T1 that times a predetermined period (step S601)

The mobile terminal 110 reports “Event S1” to the EUTRAN 410 (step S602). For example, the mobile terminal 110 transmits to the EUTRAN 410, report information that indicates a state of the mobile terminal 110 such as the presence/absence of an external power supply, the remaining battery amount, the requested downlink throughput, the movement speed, etc.

The mobile terminal 110 acquires power supply information that indicates the presence/absence of external power supply (step S603). The mobile terminal 110 determines whether the power supply information acquired this time at step S603 has changed from the power supply information acquired last time at step S603 (step S604). At the first execution of step S604, the mobile terminal 110 determines that the power supply information has not changed.

If the power supply information has changed at step S604 (step S604: YES), the mobile terminal 110 returns to step S602 and reports “Event S1” to the EUTRAN 410. If the power supply information has not changed (step S604: NO), the mobile terminal 110 acquires remaining battery amount information that indicates in which remaining amount range, the remaining battery amount of the mobile terminal 110 is included (step S605).

The mobile terminal 110 determines whether the remaining battery amount information acquired this time at step S605 has changed from the remaining battery amount information acquired last time at step S605 (step S606). At the first execution of step S606, the mobile terminal 110 determines that the remaining battery amount information has not changed.

If the remaining battery amount information has changed at step S606 (step S606: YES), the mobile terminal 110 returns to step S602 and reports “Event S1” to the EUTRAN 410. If the remaining battery amount information has not changed (step S606: NO), the mobile terminal 110 acquires movement speed information that indicates in which speed range, the movement speed of the mobile terminal 110 is included (step S607).

The mobile terminal 110 determines whether the movement speed information acquired this time at step S607 has changed from the movement speed information acquired last time at step S607 (step S608). At the first execution of step S608, the mobile terminal 110 determines that the movement speed information has not changed.

If the movement speed information has changed at step S608 (step S608: YES), the mobile terminal 110 returns to step S602 and reports “Event S1” to the EUTRAN 410. If the movement speed information has not changed (step S608: NO), the mobile terminal 110 acquires requested downlink throughput information that indicates in which throughput range, the requested downlink throughput of the mobile terminal 110 is included (step S609).

The mobile terminal 110 determines whether the requested downlink throughput information acquired this time at step S609 has changed from the requested downlink throughput information acquired last time at step S609 (step S610). At the first execution of step S610, the mobile terminal 110 determines that the requested downlink throughput information has not changed.

If the requested downlink throughput information has changed at step S610 (step S610: YES), the mobile terminal 110 returns to step S602 and reports “Event S1” to the EUTRAN 410. If the requested downlink throughput information has not changed (step S610: NO), the mobile terminal 110 determines whether the timer T1 set at step S601 has expired (step S611).

At step S611, if the timer T1 has expired (step S611: YES), the mobile terminal 110 returns to step S601 and resets the time T1 and report “Event S1”. If the timer T1 has not expired (step S611: NO), the mobile terminal 110 returns to step S603.

With the steps described above, the mobile terminal 110 can report “Event S1” to the EUTRAN 410 at the start of communication with the base station 120. The mobile terminal 110 can report “Event S1” to the EUTRAN 410 when a change occurs in the presence/absence of external power supply, the level of the remaining battery amount, the movement speed, or the requested downlink throughput. As a result, the EUTRAN 410 can efficiently be notified of the state of the mobile terminal 110. The mobile terminal 110 can report “Event S1” to the EUTRAN 410 at predetermined time intervals timed by the timer T1.

FIG. 7A is a diagram of an example of report information for Event S1. If an occurrence of “Event S1” is detected, the mobile terminal 110 transmits bits “b6”, “b5”, “b4”, “b3”, “b2”, “b1”, and “b0” described in a table 710 of FIG. 7A, for example.

The power supply information that indicates the presence/absence of power supply to the mobile terminal 110 is represented by one bit of the bit “b6”. The remaining battery amount information that indicates the remaining battery amount of the mobile terminal 110 is represented by two bits of the bits “b5” and “b4”.

The movement speed information that indicates the movement speed of the mobile terminal 110 is represented by two bits of the bits “b3” and “b2”. The requested downlink throughput information that indicates the requested downlink throughput requested for transmission to the mobile terminal 110 is represented by two bits of the bits “b1” and “b0”.

FIG. 7B is a diagram of an example of the power supply information. For example, as described in a table 720 of FIG. 7B, if the mobile terminal 110 is supplied with power, the mobile terminal 110 sets the bit “b6” of the report information to “1”. If the mobile terminal 110 is not supplied with power, the mobile terminal 110 sets the bit “b6” of the report information to “0”.

FIG. 7C is a diagram of an example of the remaining battery amount information. For example, as described in a table 730 of FIG. 7C, if the remaining battery amount of the mobile terminal 110 is greater than or equal to 75% and less than or equal to 100%, the mobile terminal 110 sets the bits “b5” and “b4” of the report information to “1” and “1”, respectively. If the remaining battery amount of the mobile terminal 110 is greater than or equal to 50% and less than 75%, the mobile terminal 110 sets the bits “b5” and “b4” of the report information to “1” and “0”, respectively.

If the remaining battery amount of the mobile terminal 110 is greater than or equal to 25% and less than 50%, the mobile terminal 110 sets the bits “b5” and “b4” of the report information to “0” and “1”, respectively. If the remaining battery amount of the mobile terminal 110 is greater than or equal to 0% and less than 25%, the mobile terminal 110 sets the bits “b5” and “b4” of the report information to “0” and “0”, respectively.

FIG. 7D is a diagram of an example of the movement speed information. For example, as described in a table 740 of FIG. 7D, if the movement speed of the mobile terminal 110 is greater than or equal to 50 [km/h], the mobile terminal 110 sets the bits “b3” and “b2” of the report information to “1” and “1”, respectively. If the movement speed of the mobile terminal 110 is greater than or equal to 15 [km/h] and less than 50 [km/h], the mobile terminal 110 sets the bits “b3” and “b2” of the report information to “1” and “0”, respectively.

If the movement speed of the mobile terminal 110 is greater than 0 [km/h] and less than 15 [km/h], the mobile terminal 110 sets the bits “b3” and “b2” of the report information to “0” and “1”, respectively. If the movement speed of the mobile terminal 110 is 0 [km/h] (stationary), the mobile terminal 110 sets the bits “b3” and “b2” of the report information to “0” and “0”, respectively.

FIG. 7E is a diagram of an example of the requested downlink throughput information. For example, as described in a table 750 of FIG. 7E, if the requested downlink throughput to the mobile terminal 110 is greater than or equal to 20 [Mbps], the mobile terminal 110 sets the bits “b1” and “b0” of the report information to “1” and “1”, respectively. If the requested downlink throughput to the mobile terminal 110 is greater than or equal to 10 [Mbps] and less than 20 [Mbps], the mobile terminal 110 sets the bits “b1” and “b0” of the report information to “1” and “0”, respectively.

If the requested downlink throughput to the mobile terminal 110 is greater than or equal to 5 [Mbps] and less than 10 [Mbps], the mobile terminal 110 sets the bits “b1” and “b0” of the report information to “0” and “1”, respectively. If the requested downlink throughput to the mobile terminal 110 is greater than or equal to 0 [Mbps] and less than 5 [Mbps], the mobile terminal 110 sets the bits “b1” and “b0” of the report information to “0” and “0”, respectively.

in is a sequence diagram of an example of a protocol flow of the reporting of Event S1 and the resource allocation. First, the mobile terminal 110 transmits to the EUTRAN 410, report information of “Event S1” through a measurement report (step S801). The report information of “Event S1” is the bits “b6”, “b5”, “b4”, “b3”, “b2”, “b1”, and “b0” depicted in FIG. 7A, for example.

The EUTRAN 410 determines based on the report information transmitted at step S801, a category that indicates the state of the mobile terminal 110 (step S802). A category determination process will be described later (see, e.g., FIG. 12). The EUTRAN 410 performs resource allocation based on the category determined at step S802 (step S803).

The EUTRAN 410 transmits, through a wireless channel of PDCCH, to the mobile terminal 110, resource allocation notification that indicates a result of the resource allocation at step S803 (step S804) and terminates a sequence of the protocol flow. The base station 120 (e.g., the EUTRAN 410) subsequently transmits a wireless signal to the mobile terminal 110, according to the resource allocation at step S803. On the other hand, the mobile terminal 110 receives the wireless signal from the base station 120, based on the resource allocation notification transmitted at step S804.

The measurement of reception quality in the downlink and the report of a measurement result of reception quality will be described.

FIG. 9A is a diagram of an example of the timing of a signal transmitted from the base station to the mobile terminal. In FIG. 9A, the horizontal direction indicates time. A downlink frame 910 depicted in FIG. 9A is a downlink frame transmitted from the base station 120 to the mobile terminal 110 in LTE-A. The downlink frame 910 is divided into sub-frames of 1 [ms], for example.

The downlink frame 910 stores a channel state indicator-reference signal (CSI-RS) 911 for every five sub-frames (5 [ms]), for example. The mobile terminal 110 measures the signal noise ratio (SNR) of the CSI-RS 911.

FIG. 9B is a diagram of an example of the timing of a signal transmitted from the mobile terminal to the base station. In FIG. 9B, the horizontal direction indicates time. An uplink frame 920 is an uplink frame transmitted from the mobile terminal 110 to the base station 120 in LTE-A. The uplink frame 920 is divided into sub-frames of 1 [ms], for example.

The uplink frame 920 stores a channel quality indicator (CQI) 921 for every five sub-frames (5 [ms]), for example. The mobile terminal 110 reports the measured SNR of the CSI-RS 911 through the CQI 921 to the EUTRAN 410.

FIG. 10 is a diagram of an example of a CQI table. A CQI table 1000 depicted in FIG. 10 is a CQI table defined in TS36.213 of 3GPP, for example.

The CQI table 1000 has “modulation”, “coding rate×1024”, and “efficiency” correlated for each “CQI index”. For example, the “CQI index” includes, for example, 16 indices from “0” to “15” and is represented by four bits, for example. A larger “CQI Index” indicates that the mobile terminal 110 can receives a wireless signal with a better SNR in a corresponding resource block.

The “modulation” indicates an adaptable modulation mode. The “coding rate×1024” indicates a code rate. The “efficiency” indicates transmission efficiency.

The mobile terminal 110 reports to the EUTRAN 410, the “CQI Index” as the CQI 921 depicted in FIG. 9B. The mobile terminal 110 reports to the EUTRAN 410, the “CQI index” for each sub-bandwidth. The sub-bandwidths will be described later (see, e.g., FIG. 11).

FIG. 11 is an example of the sub-bandwidths obtained by dividing the system bandwidth. In FIG. 11, the horizontal direction indicates frequency and the vertical direction indicates time. The frequency bandwidth available between the mobile terminal 110 and the base station 120 is divided into frequency blocks PCC and SCC1 to SCC3 as depicted in FIG. 11, for example.

The frequency block PCC is the primary CC of the bandwidth A depicted in FIG. 2, for example, and is divided into 24 sub-bandwidths, i.e., sub-bandwidths P1 to P24. Each of the frequency blocks SCC1 to SCC3 is the secondary CC of the bandwidth B depicted in FIG. 2, for example, and is divided into 24 sub-bandwidths, i.e., sub-bandwidths S1 to S24. For example, the mobile terminal 110 reports to the EUTRAN 410, a four-bit CQI (see, e.g., FIG. 10) for each of the sub-bandwidths of the frequency blocks PCC and SCC1 to SCC3.

FIG. 12 is a flowchart of an example of the category determination process. The EUTRAN 410 executes, for example, the following steps based on the report information from the mobile terminal 110 at step S802 depicted in FIG. 8. First, the EUTRAN 410 determines whether the mobile terminal 110 is supplied with power from an external source (step S1201).

At step S1201, if power is supplied from an external source (step S1201: YES), the EUTRAN 410 determines whether the movement speed of the mobile terminal 110 is less than 15 [km/h] (step S1202). If the movement speed is less than 15 [km/h] (step S1202: YES), the EUTRAN 410 determines the category as “category 1-1” (step S1203) and terminates a sequence of the determination process.

If the movement speed is greater than or equal to 15 [km/h] at step S1202 (step S1202: NO), the EUTRAN 410 determines if the movement speed of the mobile terminal 110 is greater than or equal to 50 [km/h] (step S1204).

If the movement speed is greater than or equal to 50 [km/h] at step 1204 (step S1204: YES), the EUTRAN 410 determines the category as “category 1-2” (step S1205) and terminates a sequence of the determination process. If the movement speed is less than 50 [km/h] (step S1204: NO), the EUTRAN 410 determines the category as “category 3” (step S1206) and terminates a sequence of the determination process. If power is not supplied from an external source (step S1201: NO), the EUTRAN 410 determines if the remaining battery amount of the mobile terminal 110 is greater than or equal to 50% (step S1207). If the remaining battery amount is greater than or equal to 50% (step S1207: YES), the EUTRAN 410 proceeds to step S1202.

If the remaining battery amount is less than 50% at step S1207 (step S1207: NO), the EUTRAN 410 determines whether the remaining battery amount of the mobile terminal 110 is less than 25% (step S1208). If the remaining battery amount is less than 25% (step S1208: YES), the EUTRAN 410 determines whether the movement speed of the mobile terminal 110 is less than 15 [km/h] (step S1209). If the movement speed is less than 15 [km/h] (step S1209: YES), the EUTRAN 410 determines the category as “category 2-1” (step S1210) and terminates a sequence of the determination process.

If the movement speed is greater than or equal to 15 [km/h] at step S1209 (step S1209: NO), the EUTRAN 410 determines whether the movement speed of the mobile terminal 110 is greater than or equal to 50 [km/h] (step S1211). If the movement speed is greater than or equal to 50 [km/h] (step S1211: YES), the EUTRAN 410 determines the category as “category 2-2” (step S1212) and terminates a sequence of the determination process.

If the movement speed is less than 50 [km/h] (step S1211: NO) at step S1211, the EUTRAN 410 determines the category as “category 3” (step S1213) and terminates a sequence of the determination process.

If the remaining battery amount is greater than or equal to 25% at step S1208 (step S1208: NO), the EUTRAN 410 proceeds to step S1213.

With the steps described above, if the battery of the mobile terminal 110 is expected to last for a long time and the mobile terminal 110 is moving at low speed or in a stopped state, the category of the mobile terminal 110 can be determined as “category 1-1”. If the battery of the mobile terminal 110 is expected to last for a long time and the mobile terminal 110 is moving at high speed, the category of the mobile terminal 110 can be determined as “category 1-2”.

If the battery of the mobile terminal 110 is expected to last only for a short time and the mobile terminal 110 is moving at low speed or in a stopped state, the category of the mobile terminal 110 can be determined as “category 2-1”. If the battery of the mobile terminal 110 is expected to last only for a short time and the mobile terminal 110 is moving at high speed, the category of the mobile terminal 110 can be determined as “category 2-2”.

FIG. 13 is a flowchart of an example of a resource allocation process. The EUTRAN 410 executes, for example, the following steps based on a category determination result from the process depicted in FIG. 12 at step S803 depicted in FIG. 8. The EUTRAN 410 determines whether the determined category is “category 1-1” (step S1301).

If the determined category is “category 1-1” at step S1301 (step S1301: YES), the EUTRAN 410 proceeds to step S1302. In particular, the EUTRAN 410 performs the resource allocation of the primary CC and the secondary CC based on the CQI and the requested downlink throughput reported by the mobile terminal 110 (step S1302) and terminates a sequence of the resource allocation process.

In the resource allocation at step S1302, the EUTRAN 410 makes the ratio of the primary CC to the secondary CC smaller as compared to resource allocation at step S1304 described later.

If the determined category is not “category 1-1” at step S1301 (step S1301: NO), the EUTRAN 410 determines whether the determined category is “category 1-2” (step S1303).

If the determined category is “category 1-2” at step S1303 (step S1303: YES), the EUTRAN 410 proceeds to step S1304. In particular, the EUTRAN 410 performs the resource allocation of the primary CC and the secondary CC based on the CQI and the requested downlink throughput reported by the mobile terminal 110 (step S1304) and terminates a sequence of the resource allocation process.

In the resource allocation at step S1304, the EUTRAN 410 makes the ratio of the primary CC to the secondary CC larger as compared to the resource allocation at step S1302.

If the determined category is not “category 1-2” at step S1303 (step S1303: NO), the EUTRAN 410 determines whether the determined category is “category 2-1” (step S1305).

If the determined category is “category 2-1” at step S1305 (step S1305: YES), the EUTRAN 410 proceeds to step S1306. In particular, the EUTRAN 410 performs the resource allocation of only the secondary CC based on the CQI reported by the mobile terminal 110 (step S1306) and terminates a sequence of the resource allocation process.

In the resource allocation at step S1306, the EUTRAN 410 does not reflect the requested downlink throughput reported by the mobile terminal 110 on the resource allocation and performs the resource allocation at 5 [Mbps] or less, for example.

If the determined category is not “category 2-1” at step S1305 (step S1305: NO), the EUTRAN 410 determines whether the determined category is “category 2-2” (step S1307).

If the determined category is “category 2-2” at step S1307 (step S1307: YES), the EUTRAN 410 proceeds to step S1308. In particular, the EUTRAN 410 performs the resource allocation of only the primary CC based on the CQI reported by the mobile terminal 110 (step S1308) and terminates a sequence of the resource allocation process.

In the resource allocation at step S1308, the EUTRAN 410 does not reflect the requested downlink throughput reported by the mobile terminal 110 on the resource allocation and performs the resource allocation at 5 [Mbps] or less, for example.

If the determined category is not “category 2-2” at step S1307 (step S1307: NO), the EUTRAN 410 proceeds to step S1309. In particular, the EUTRAN 410 performs the resource allocation based on the CQI reported by the mobile terminal 110 (step S1309) and terminates a sequence of the resource allocation process.

As a result, if the mobile terminal 110 is supplied with power or if the remaining battery amount of the mobile terminal 110 is high, the primary CC and the secondary CC may be allocated. If the mobile terminal 110 is not supplied with power and the remaining battery amount of the mobile terminal 110 is low, only one among the primary CC and the secondary CC is allocated.

If the mobile terminal 110 is supplied with power or if the remaining battery amount of the mobile terminal 110 is high, the allocation exceeding 5 [Mbps] can be performed according to the requested downlink throughput. If the mobile terminal 110 is not supplied with power and the remaining battery amount of the mobile terminal 110 is low, the allocation can be performed with an upper limit of 5 [Mbps].

If the mobile terminal 110 is moving at low speed or in a stopped state, the allocation can be performed such that the ratio of the secondary CC to the primary CC becomes larger as compared to when the mobile terminal 110 is moving at high speed.

FIG. 14A is a diagram of an example of a configuration of the mobile terminal according to the first embodiment. FIG. 14B is a diagram of an example of signal flow in the configuration of the mobile terminal depicted in FIG. 14A. As depicted in FIGS. 14A and 14B, the mobile terminal 110 includes antennas 1401, 1402, an LTE-A device 1410, a WLAN device 1420, a central processing unit (CPU) 1431, and memory 1432. The mobile terminal 110 also includes a display unit 1441, an operating unit 1442, a microphone 1443, a speaker 1444, a power supply detecting unit 1451, a remaining battery amount detecting unit 1452, a movement speed detecting unit 1453, and a requested-downlink-throughput detecting unit 1454.

The LTE-A device 1410 is a communication circuit that executes a communication process of the LTE-A mode. For example, the LTE-A device 1410 includes an LTE-A wireless unit 1411 and an LTE-A baseband unit 1412. The LTE-A wireless unit 1411 wirelessly transmits a transmission signal output from the LTE-A baseband unit 1412, via the antenna 1401, in the LTE-A mode. The LTE-A wireless unit 1411 outputs to the LTE-A baseband unit 1412, a reception signal received, via the antenna 1401, in the LTE-A mode.

The LTE-A baseband unit 1412 executes a baseband process on a transmission signal output from the CPU 1431 and outputs to the LTE-A wireless unit 1411, the transmission signal subjected to the baseband process. The LTE-A baseband unit 1412 executes a baseband process on a reception signal output from the LTE-A wireless unit 1411 and outputs to the CPU 1431, the reception signal subjected to the baseband process.

The WLAN device 1420 is a communication circuit that executes a communication process of the WLAN mode. For example, the WLAN device 1420 includes a WLAN wireless unit 1421 and a WLAN baseband unit 1422. The WLAN wireless unit 1421 wirelessly transmits a transmission signal output from the WLAN baseband unit 1422, via the antenna 1402, in the WLAN mode. The WLAN wireless unit 1421 outputs to the WLAN baseband unit 1422, a reception signal received, via the antenna 1402, in the WLAN mode.

The WLAN baseband unit 1422 executes a baseband process on a transmission signal output from the CPU 1431 and outputs to the WLAN wireless unit 1421, the transmission signal subjected to the baseband process. The WLAN baseband unit 1422 executes a baseband process on a reception signal output from the WLAN wireless unit 1421 and outputs to the CPU 1431, the reception signal subjected to the baseband process.

The CPU 1431 is responsible for overall control of the mobile terminal 110. For example, the steps depicted in FIG. 6 are executed by the CPU 1431.

The memory 1432 includes main memory and auxiliary memory, for example. The main memory is random access memory (RAM), for example. The main memory is used as a work area of the CPU 1431. The auxiliary memory is non-volatile memory such as a magnetic disk and a flash memory. The auxiliary memory stores various programs for operating the mobile terminal 110. The programs stored in the auxiliary memory are loaded to the main memory and executed by the CPU 1431.

The display unit 1441 displays information for a user of the mobile terminal 110, under the control of the CPU 1431. The display unit 1441 may be implemented by a liquid crystal display, for example. The operating unit 1442 receives an operation from the user of the mobile terminal 110 and notifies the CPU 1431 of the received contents. The operating unit 1442 may be implemented by switches and keys, for example. The display unit 1441 and the operating unit 1442 may be implemented by a touch panel, etc. The microphone 1443 receives audio input from the user and notifies the CPU 1431 of the received contents. The speaker 1444 outputs sound to the user of the mobile terminal 110, under the control of the CPU 1431.

The power supply detecting unit 1451 detects the presence/absence of an external power supply of the mobile terminal 110. The power supply detecting unit 1451 outputs the bit “b6” (FIG. 7A) that indicates the detection result. For example, the power supply detecting unit 1451 determines whether a power connector supplying power is connected to a terminal of the mobile terminal 110, thereby detecting the presence/absence of power supply.

The remaining battery amount detecting unit 1452 detects the remaining battery amount of the mobile terminal 110. The remaining battery amount detecting unit 1452 outputs the bits “b5” and “b4” (FIG. 7A) that indicate the detection result. For example, the remaining battery amount detecting unit 1452 measures battery voltage from current supplied from the battery of the mobile terminal 110, thereby detecting the remaining battery amount.

The movement speed detecting unit 1453 detects the movement speed of the mobile terminal 110. The movement speed detecting unit 1453 outputs the bits “b3” and “b2” (FIG. 7A) that indicate the detection result. The movement speed detecting unit 1453 detects the movement speed by using an acceleration sensor, for example. This is not a limitation to the detection of the movement speed by the movement speed detecting unit 1453 and various methods are available. For example, the movement speed detecting unit 1453 may detect the movement speed based on the frequency and the phase of a signal received by the antenna 1401.

The movement speed detecting unit 1453 may acquire positional information of the mobile terminal 110 with the Global Positioning System (GPS), etc. to detect the movement speed based on a change indicated by position information. The movement speed detecting unit 1453 may detect the movement speed based on a change of the base station that communicates with the mobile terminal 110.

The requested-downlink-throughput detecting unit 1454 detects the downlink communication throughput requested by the mobile terminal 110 to the network. The requested-downlink-throughput detecting unit 1454 outputs the bits “b1” and “b0” (FIG. 7A) that indicate the detection result. The downlink communication throughput detection by the requested-downlink-throughput detecting unit 1454 will be described later (see, e.g., FIG. 15).

The power supply detecting unit 1451, the remaining battery amount detecting unit 1452, the movement speed detecting unit 1453, and the requested-downlink-throughput detecting unit 1454 may be implemented by an electronic circuit, etc. that is different from the CPU 1431, for example. Alternatively, the power supply detecting unit 1451, the remaining battery amount detecting unit 1452, the movement speed detecting unit 1453, and the requested-downlink-throughput detecting unit 1454 may be implemented by executing a program on the CPU 1431, for example.

The detecting unit 111 depicted in FIGS. 1A and 1B may be implemented by the power supply detecting unit 1451, the remaining battery amount detecting unit 1452, the movement speed detecting unit 1453, and the requested-downlink-throughput detecting unit 1454, for example. The transmitting unit 112 and the receiving unit 113 depicted in FIGS. 1A and 1B may be implemented by the antenna 1401 and the LTE-A device 1410 or the antenna 1402 and the WLAN device 1420, for example.

FIG. 15 is a diagram of an example of the detection of the requested downlink throughput. As depicted in FIG. 15, for example, the mobile terminal 110 includes an application client 1510, a storage unit 1520, and a requested-downlink-throughput setting unit 1530. The application client 1510 and the requested-downlink-throughput setting unit 1530 may be implemented by executing a program on the CPU 1431, for example. The storage unit 1520 may be implemented by the memory 1432, for example.

The application client 1510 is a client of an application that performs a storage type streaming service (video streaming service). In the application client 1510, for example, “form1” to “form3” may be selected as the quality of video data downloaded from a server in this description. The application client 1510 notifies the requested-downlink-throughput setting unit 1530 of the form that has been selected (selected form).

The storage unit 1520 stores a table 1521. In the table 1521, the selected form in the application client 1510 is correlated with the requested downlink throughput. In an example depicted in FIG. 15, “form1” to “form3” are correlated with 5 [Mbps], 10 [Mbps], and 20 [Mbps], respectively, in the table 1521.

The requested-downlink-throughput setting unit 1530 acquires in the table 1521 stored in the storage unit 1520, the requested downlink throughput correlated with the selected form notified by the application client 1510. The requested-downlink-throughput setting unit 1530 sets the acquired requested downlink throughput as the requested downlink throughput of the mobile terminal 110.

The requested-downlink-throughput detecting unit 1454 detects the requested downlink throughput of the mobile terminal 110 by acquiring the requested downlink throughput set by the requested-downlink-throughput setting unit 1530. For example, if “form1” is set in the application client 1510, the requested-downlink-throughput setting unit 1530 sets 5 [Mbps] as the requested downlink throughput.

The multiple application clients 1510 may exist and, in this case, the table 1521 corresponding to each of the application clients 1510 is stored in the storage unit 1520. The requested-downlink-throughput setting unit 1530 acquires the requested downlink throughput from the table 1521 for each of the application clients 1510. The requested-downlink-throughput setting unit 1530 sets the sum of the acquired requested downlink throughputs as the requested downlink throughput of the mobile terminal 110, for example.

The service of the application client 1510 is not limited to the video streaming service, and various services such as Voice over IP (VoIP), videophone, and file transfer are applicable.

As described above, the requested-downlink-throughput detecting unit 1454 refers to the table 1521 (correlation information) of a state of an application executable in the mobile terminal 110 and a data amount requested by the mobile terminal 110. The requested-downlink-throughput detecting unit 1454 detects the data amount corresponding to the state of the application under execution by the mobile terminal 110 based on the table 1521.

FIG. 16A is a diagram of an example of a configuration of the base station according to the first embodiment. FIG. 16B is a diagram of signal flow in the configuration of the base station depicted in FIG. 16A. Examples depicted in FIGS. 16A and 16B will be described as a case where the EUTRAN 410 (control apparatus 121) is equipped at the base station 120.

As depicted in FIGS. 16A and 16B, the base station 120 includes an antenna 1601, a duplexer 1602, an LTE-A reception RF unit 1603, an LTE-A reception modem 1604, a user data extracting unit 1605, and a CQI extracting unit 1606. The base station 120 also includes an event extracting unit 1607, a category determining unit 1608, a downlink throughput extracting unit 1609, a physical resource allocation control unit 1610, an LTE-A transmission modem 1611, and an LTE-A transmission RF unit 1612.

The antenna 1601 receives wireless signals from the mobile terminal 110 and outputs the reception signals to the duplexer 1602. The antenna 1601 wirelessly transmits to the mobile terminal 110, transmission signals output from the duplexer 1602.

The duplexer 1602 outputs to the LTE-A reception RF unit 1603, the reception signals output from the antenna 1601. The duplexer 1602 outputs to the antenna 1601, the transmission signals output from the LTE-A transmission RF unit 1612.

The LTE-A reception RF unit 1603 performs frequency conversion of the reception signal of a radio frequency (RF) bandwidth output from the duplexer 1602. The frequency conversion is conversion into a baseband, for example. The LTE-A reception RF unit 1603 outputs to the LTE-A reception modem 1604, the reception signal subjected to the frequency conversion.

The LTE-A reception modem 1604 acquires reception data by executing a reception process receiving the reception signal output from the LTE-A reception RF unit 1603. The LTE-A reception modem 1604 outputs the reception data acquired by the reception process to the user data extracting unit 1605, the CQI extracting unit 1606, and the event extracting unit 1607.

The user data extracting unit 1605 extracts and outputs user data from the reception data output from the LTE-A reception modem 1604. The CQI extracting unit 1606 extracts and outputs to the physical resource allocation control unit 1610, the CQI from the reception data output from the LTE-A reception modem 1604. The CQI extracted by the CQI extracting unit 1606 is the “CQI index” depicted in FIG. 10, for example.

The event extracting unit 1607 extracts the report information of “Event S1” from the reception data output from the LTE-A reception modem 1604. The report information extracted by the event extracting unit 1607 is the bits “b6”, “b5”, “b4”, “b3”, “b2”, “b1”, and “b0” depicted in FIG. 7A, for example. The event extracting unit 1607 outputs the extracted report information of “Event S1” to the category determining unit 1608 and the downlink throughput extracting unit 1609.

The category determining unit 1608 determines a category of the state of the mobile terminal 110 based on the report information of “Event S1” output from the event extracting unit 1607. For example, the category determining unit 1608 determines the category based on the bits “b6”, “b5”, “b4”, “b3”, and “b2” included in the report information. For example, the category determining unit 1608 determines the category through the determination process depicted in FIG. 12. The category determining unit 1608 notifies the physical resource allocation control unit 1610 of the determined category.

The downlink throughput extracting unit 1609 extracts the requested downlink throughput information of the mobile terminal 110 from the report information of “Event S1” output from the event extracting unit 1607. The requested downlink throughput information extracted by the downlink throughput extracting unit 1609 is the bits “b1” and “b0” included in the report information. The downlink throughput extracting unit 1609 outputs the extracted requested downlink throughput information to the physical resource allocation control unit 1610.

The physical resource allocation control unit 1610 is a scheduler that allocates physical resources for wireless signals transmitted to the mobile terminal 110. For example, the physical resource allocation control unit 1610 performs the allocation based on the category supplied from the category determining unit 1608 and the requested downlink throughput information output from the downlink throughput extracting unit 1609.

The physical resource allocation control unit 1610 preferentially allocates a sub-bandwidth of a large CQI output from the CQI extracting unit 1606. For example, the physical resource allocation control unit 1610 executes the resource allocation process depicted in FIG. 13. The physical resource allocation control unit 1610 notifies the LTE-A transmission modem 1611 of the result of the physical resource allocation.

The transmission data and the allocation result output from the physical resource allocation control unit 1610 are input to the LTE-A transmission modem 1611. The LTE-A transmission modem 1611 allocates the physical resources for the transmission data, based on the allocation result output from the physical resource allocation control unit 1610, thereby generating a transmission signal. The LTE-A transmission modem 1611 outputs the generated transmission signal to the LTE-A transmission RF unit 1612. The LTE-A transmission modem 1611 stores the allocation result output from the physical resource allocation control unit 1610 into the transmission signal to notify the mobile terminal 110 of the result of the physical resource allocation.

The LTE-A transmission RF unit 1612 converts the transmission signal output from the LTE-A transmission modem 1611 into a transmission signal of the RF bandwidth and outputs the transmission signal to the duplexer 1602.

The user data extracting unit 1605, the CQI extracting unit 1606, the event extracting unit 1607, the category determining unit 1608, the downlink throughput extracting unit 1609, and the physical resource allocation control unit 1610 may be implemented by an electronic circuit such as a CPU, for example.

As described above, according to the communication system 100 of the first embodiment, the mobile terminal 110 notifies the control apparatus 121 (network side) of a terminal state such as the remaining battery amount. The control apparatus 121 determines the category of the mobile terminal 110, based on the terminal state supplied from the mobile terminal 110 to perform the downlink resource allocation, according to the determined category. Thus, the communication resources can be used efficiently.

A second embodiment will be described in terms of portions that differ from the first embodiment. In the communication system 100 according to the second embodiment, the category of the state of the mobile terminal 110 is determined in the mobile terminal 110.

FIG. 17 is a diagram of an example of the report information transmitted by the mobile terminal according to the second embodiment. If an occurrence of “Event S1” is detected, the mobile terminal 110 determines the category of the state of the mobile terminal 110. The mobile terminal 110 transmits bits “b4”, “b3”, “b2”, “b1”, and “b0” described in a table 1700 of FIG. 17 as report information including category information and requested downlink throughput information.

The category information that indicates the category of the state of the mobile station 110 is represented by three bits of the bits “b4”, “b3”, and “b2”. The requested downlink throughput information that indicates the requested downlink throughput requested for transmission to the mobile terminal 110 is represented by two bits of the bits “b1” and “b0”.

FIG. 18 is a diagram of an example of the category information. For example, as depicted in category information 1800 of FIG. 18, if the category determination result is “category 2-2”, the mobile terminal 110 sets the bits “b4”, “b3”, and “b2” of the category information to “1”, “0”, and “0”, respectively. If the category determination result is “category 2-1”, the mobile terminal 110 sets the bits “b4”, “b3”, and “b2” of the category information to “0”, “1”, and “1”, respectively.

If the category determination result is “category 1-2”, the mobile terminal 110 sets the bits “b4”, “b3”, and “b2” of the category information to “0”, “1”, and “0”, respectively. If the category determination result is “category 1-1”, the mobile terminal 110 sets the bits “b4”, “b3”, and “b2” of the category information to “0”, “0”, and “1”, respectively. If the category determination result is “category 3”, the mobile terminal 110 sets the bits “b4”, “b3”, and “b2” of the category information to “0”, “0”, and “0”, respectively.

FIG. 19 is a sequence diagram of an example of protocol flow of the reporting of the category and the resource allocation. First, the mobile terminal 110 determines the category of the state of the mobile terminal 110 (step S1901). The mobile terminal 110 transmits through a measurement report to the EUTRAN 410, category information that indicates the category determined at step S1901 (step S1902). The category information is the bits “b4”, “b3”, and “b2” depicted in FIG. 17, for example.

The EUTRAN 410 performs the resource allocation based on the category indicated by the category information transmitted at step S1902 (step S1903). The resource allocation process at step S1903 is the same as the resource allocation process depicted in FIG. 13, for example.

The EUTRAN 410 transmits through a wireless channel of PDCCH, to the mobile terminal 110, resource allocation notification that indicates the result of the resource allocation at step S1903 (step S1904) and terminates a sequence of the protocol flow.

The base station 120 (e.g., the EUTRAN 410) subsequently transmits a wireless signal to the mobile terminal 110 according to the resource allocation at step S1903. Meanwhile, the mobile terminal 110 receives the wireless signal from the base station 120 based on the resource allocation notification transmitted at step S1904.

FIG. 20A is a diagram of an example of a configuration of the mobile terminal according to the second embodiment. FIG. 20B is a diagram of an example of signal flow in the configuration of the mobile terminal depicted in FIG. 20A. In FIGS. 20A and 20B, portions identical to those depicted in FIGS. 14A and 14B are denoted by the same reference numerals used in and FIGS. 14A and 14B will not be described.

As depicted in FIGS. 20A and 20B, the mobile terminal 110 includes a category determining unit 2010 in addition to the configuration depicted in FIGS. 14A and 14B. The power supply detecting unit 1451, the remaining battery amount detecting unit 1452, and the movement speed detecting unit 1453 output respective detection results to the category determining unit 2010.

The category determining unit 2010 determines the category of the state of the mobile terminal 110 based on the respective detection results output from the power supply detecting unit 1451, the remaining battery amount detecting unit 1452, and the movement speed detecting unit 1453. The category determination process by the category determining unit 2010 may be the same process as the determination process depicted in FIG. 12, for example.

FIG. 21A is a diagram of an example of a configuration of the base station according to the second embodiment. FIG. 21B is a diagram of signal flow in the configuration of the base station depicted in FIG. 21A. In FIGS. 21A and 21B, portions identical to those depicted in FIGS. 16A and 16B are denoted by the same reference numerals used in FIGS. 16A and 16B and will not be described.

As depicted in FIGS. 21A and 21B, the base station 120 according to the second embodiment may include a category extracting unit 2101 instead of the category determining unit 1608 depicted in FIGS. 16A and 16B. The event extracting unit 1607 outputs the reception data to the category extracting unit 2101 and the downlink throughput extracting unit 1609.

The category extracting unit 2101 extracts the category information from the reception data output from the event extracting unit 1607. The category information extracted from the category extracting unit 2101 is the bits “b4”, “b3”, and “b2” depicted in FIG. 17. The category extracting unit 2101 outputs the extracted category information to the physical resource allocation control unit 1610.

As described above, according to the communication system 100 of the second embodiment, the mobile terminal 110 determines the category of the mobile terminal 110 based on a terminal state such as the remaining battery amount and notifies the control apparatus 121 (network side) of the determined category. The control apparatus 121 performs the downlink resource allocation according to the category supplied from the mobile terminal 110. Thus, the communication resources can be used efficiently.

As described above, according to the communication system, the communication method, the mobile terminal, and the control apparatus, the communication resources can be used efficiently.

For example, as depicted in FIG. 2, while 80 [MHz] using the component carrier 210 and the component carriers 221 to 223 can be used, if the remaining battery amount of the mobile terminal 110 is low, the concurrent use of the four bandwidths is not efficient from the standpoint of current consumption. On the other hand, if the mobile terminal 110 is supplied with power at home or in an office, the power supply to the mobile terminal 110 is ensured and therefore, the allocation of 80 [MHz] is available.

If the movement speed of the mobile terminal 110 is greater than or equal to 50 [km/h], handover of the mobile terminal 110 frequently occurs between microcells of the secondary CC and therefore, it is not efficient to allocate a large amount of the secondary CC from the standpoint of battery life.

On the other hand, according to the communication system 100, the mobile terminal 110 notifies the control apparatus 121 (network side) of a terminal state such as the remaining battery amount. The control apparatus 121 performs the downlink resource allocation according to the terminal state supplied from the mobile terminal 110. Thus, the communication resources can be used efficiently.

An aspect of the present invention enables communication resources to be used efficiently.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication system comprising:
a mobile terminal that is configured to enable reception of a wireless signal by concurrently using a cell of a first frequency bandwidth and a cell of a second frequency bandwidth that is different from the first frequency bandwidth, the cell of the second frequency bandwidth having a range narrower than the cell of the first frequency bandwidth, the mobile terminal transmitting state information that indicates at least one among presence/absence of power supply to the mobile terminal and a remaining battery amount of the mobile terminal; and
a control apparatus that is configured to allocate communication resources for the wireless signal transmitted by a base station to the mobile terminal, the control apparatus switching according to the state information transmitted by the mobile terminal, a first allocation process of allocating the first frequency bandwidth and the second frequency bandwidth for the wireless signal and a second allocation process of allocating one among the first frequency bandwidth and the second frequency bandwidth for the wireless signal.

2. The communication system according to claim 1, wherein
the mobile terminal transmits the state information that indicates the presence/absence of power supply,
the control apparatus allocates the communication resources by the first allocation process in the presence of power supply, and
the control apparatus allocates the communication resources by the second allocation process in the absence of power supply.

3. The communication system according to claim 1, wherein
the mobile terminal transmits the state information that indicates the remaining battery amount,
the control apparatus allocates the communication resources by the first allocation process when the remaining battery amount is higher than a first remaining amount, and
the control apparatus allocates communication resources by the second allocation process when the remaining battery amount is lower than a second remaining amount that is at most equal to the first remaining amount.

4. The communication system according to claim 3, wherein
the mobile terminal transmits the state information that indicates the presence/absence of power supply and the remaining battery amount,
the control apparatus allocates the communication resources by the first allocation process in any one among a case of the presence of power supply and a case when the remaining battery amount is higher than the first remaining amount, and
the control apparatus allocates the communication resources by the second allocation process when the remaining battery amount is lower than the second remaining amount in the absence of power supply.

5. The communication system according to claim 1, wherein the mobile terminal transmits the state information that indicates a data amount requested for transmission from the base station to the mobile terminal,
the control apparatus switches based on at least any one among the presence/absence of power supply and the remaining battery amount, an allocation process that has a predetermined data amount as an upper limit and an allocation process that according to the data amount indicated by the state information transmitted by the mobile terminal, enables allocation exceeding the predetermined data amount.

6. The communication system according to claim 5, wherein
the mobile terminal transmits the state information that indicates the presence/absence of power supply,
the control apparatus allocates, in the presence of power supply, the communication resources by the first allocation process that according to the data amount, enables allocation exceeding the predetermined data amount, and
the control apparatus allocates, in the absence of power supply, the communication resources by the second allocation process that has the predetermined data amount as an upper limit.

7. The communication system according to claim 5, wherein
the mobile terminal transmits the state information that indicates the remaining battery amount,
the control apparatus, when the remaining battery amount is higher than a first remaining amount, allocates the communication resources by the first allocation process that according to the data amount, enables allocation exceeding the predetermined data amount, and
the control apparatus, when the remaining battery amount is less than a second remaining amount that is at most equal to the first remaining amount, allocates the communication resources by the second allocation process that has the predetermined data amount as an upper limit.

8. The communication system according to claim 7, wherein
the mobile terminal transmits the state information that indicates the presence/absence of power supply and the remaining battery amount,
the control apparatus, in any one among a case of the presence of the power supply and a case when the remaining battery amount is higher than the first remaining amount, allocates the communication resources by the first allocation process that the according to the data amount, enables allocation exceeding the predetermined data amount, and
the control apparatus allocates the communication resources by the second allocation process that has the predetermined data amount as an upper limit, when the remaining battery amount is lower than the second remaining amount in the absence of power supply.

9. The communication system according to claim 5, wherein the mobile terminal detects based on correlation information of a state of an application executable at the mobile terminal and a data amount requested for transmission to the mobile terminal, the data amount corresponding to the state of the application under execution by the mobile terminal.

10. The communication system according to claim 1, wherein
the mobile terminal transmits the state information that indicates movement speed of the mobile terminal, and
the control apparatus allocates the communication resources to the wireless signal such that a ratio between the first frequency bandwidth and the second frequency bandwidth is differs according to the movement speed indicated by the state information transmitted by the mobile terminal.

11. The communication system according to claim 10, wherein
the control apparatus, when the movement speed is lower than a first speed, allocates the communication resources to the wireless signal such that a ratio of the second frequency bandwidth to the first frequency bandwidth is larger as compared to when the movement speed is higher than a second speed that is at least equal to the first speed.

12. The communication system according to claim 10, wherein
the movement speed is an average movement speed during a predetermined period.

13. The communication system according to claim 1, wherein
the mobile terminal transmits the state information that indicates the presence/absence of power supply, when the presence/absence of power supply changes.

14. The communication system according to claim 1, wherein
the mobile terminal determines among different remaining amount ranges, a remaining amount range in which the remaining battery amount is included, and
the mobile terminal transmits the state information that indicates the remaining battery amount, when a determination result changes.

15. The communication system according to claim 5, wherein
the mobile terminal determines among different amount ranges, an amount range in which the requested data amount is included, and
the mobile terminal transmits the state information when a determination result changes.

16. The communication system according to claim 10, wherein
the mobile terminal determines among different speed ranges, a speed range in which the movement speed is included, and
the mobile terminal transmits the state information, when a determination result changes.

17. The communication system according to claim 1, wherein
the mobile terminal transmits the state information at start of communication with the base station.

18. The communication system according to claim 1, wherein
the mobile terminal periodically transmits the state information.

19. A communication method comprising:
transmitting, by a mobile terminal, state information that indicates at least one among presence/absence of power supply to the mobile terminal and a remaining battery amount of the mobile terminal, the mobile terminal being configured to enable reception of a wireless signal by concurrently using a cell of a first frequency bandwidth and a cell of a second frequency bandwidth that is different from the first frequency bandwidth, the cell of the second frequency bandwidth having a range narrower than the cell of the first frequency bandwidth; and
switching, by a control apparatus and according to the state information transmitted by the mobile terminal, a first allocation process of allocating the first frequency bandwidth and the second frequency bandwidth for the wireless signal transmitted by a base station to the mobile terminal and a second allocation process of allocating one among the first frequency bandwidth and the second frequency bandwidth for the wireless signal, the control apparatus being configured to allocate communication resources for the wireless signal.

20. A mobile terminal comprising:
a processor that is configured to:
detect at least one among presence/absence of power supply to the mobile terminal and a remaining battery amount of the mobile terminal;
transmit to a control apparatus that allocates communication resources for a wireless signal that is transmitted by a base station to the mobile terminal, state information that indicates a result of detection; and
enable reception of the wireless signal by concurrently using a cell of a first frequency bandwidth and a cell of a second frequency bandwidth that is different from the first frequency bandwidth, the cell of the second frequency bandwidth having a range narrower than the cell of the first frequency bandwidth, the wireless signal being transmitted from the base station through the communication resources allocated by the control apparatus, according to the state information transmitted by the processor.

21. A control apparatus comprising:
a processor that is configured to:
receive state information from a mobile terminal that is configured to enable reception of a wireless signal by concurrently using a cell of a first frequency bandwidth and a cell of a second frequency bandwidth that is different from the first frequency bandwidth, the cell of the second frequency bandwidth having a range narrower than the cell of the first frequency bandwidth, the state information indicating at least one among presence/absence of power supply to the mobile terminal and a remaining battery amount of the mobile terminal; and
allocate communication resources for the wireless signal that is transmitted by a base station to the mobile terminal, the processor switching according to the received state information, a first allocation process of allocating the first frequency bandwidth and the second frequency bandwidth for the wireless signal and a second allocation process of allocating one among the first frequency bandwidth and the second frequency bandwidth for the wireless signal.
